(19) United States
(12) Patent Application Publication
(10) Pub. No.: US 2019/0080463 A1
(43) Pub. Date: Mar. 14, 2019

(54) REAL-TIME HEIGHT MAPPING

(71) Applicant: Imperial College of Science, Technology and Medicine, London (GB)

(72) Inventors: Andrew DAVISON, London (GB); Stefan LEUTENEGGER, London (GB); Jacek ZIENKIEWICZ, London (GB)

(21) Appl. No.: 16/188,693

(22) Filed: Nov. 13, 2018

Related U.S. Application Data
(63) Continuation of application No. PCT/GB2017/051333, filed on May 12, 2017.

(30) Foreign Application Priority Data
May 13, 2016 (GB) 1608471.7

(51) Int. Cl. G06T 7/579; G05D 1/02; G06T 15/20; G06T 17/05

(52) U.S. Cl. CPC G06T 7/579; G05D 1/0274; G05D 1/0253; G06T 15/205; G06T 2207/30261; G05D 2201/0215; G06T 2207/10028; G06T 2207/30244; G06T 17/05

(57) ABSTRACT

Certain examples described herein relate to apparatus and techniques suitable for mapping a 3D space. In examples, a height map is generated in real-time from depth map and camera pose inputs provided from at least one image capture device. The height map may be processed to generate a free-space map to determine navigable portions of the space by a robotic device.

### CROSS-REFERENCE TO RELATED APPLICATIONS

This application is a continuation of International Application No. PCT/GB2017/051333, filed May 12, 2017, which is a claims priority to GB Application No. GB1608471.7, filed May 13, 2016, under 35 U.S.C. § 119(a). Each of the above-referenced patent applications is incorporated by reference in its entirety.

### BACKGROUND OF THE INVENTION

### Field of the Invention

The present invention relates to techniques for mapping a three-dimensional (3D) space. The invention has particular, but not exclusive, relevance to generating a height map based on a sequence of images from a monocular camera, the sequence having been captured during a movement of the camera relative to a 3D space.

### Description of the Related Technology

In the field of computer vision and robotics, in order to navigate a 3D space, such as an interior room, robotic devices may employ a range of techniques.

Simple navigation solutions may rely on limited perception and simple algorithms, for example an infra-red or ultrasonic sensor that detects objects within a line of site that may then be avoided.

Alternatively, more advanced solutions may employ tools and methods to construct a representation of a surrounding 3D space to enable navigation of the 3D space. Known techniques for constructing a representation of a 3D space include “structure from motion” and “multi-view stereo”. Certain techniques, known as “sparse”, use a reduced number of points or features, for example ten to a hundred, to generate a representation. These may be contrasted with “dense” techniques that generate representations with many thousands or millions of points. Typically, “sparse” techniques are easier to implement in real-time, for example at a frame rate of 30 frames-per-second or so since they use a limited number of points or features and thus limit the extent of the processing compared to more resource-intensive “dense” mapping techniques.

While great progress has been made around techniques such as “Simultaneous Localisation And Mapping” (SLAM) (see J. Engel, T. Schoeps, and D. Cremers. “LSD-SLAM: Large-scale direct monocular SLAM”. In Proceedings of the European Conference on Computer Vision (ECCV), 2014, and R. Mur-Artal and J. D. Tardos. “ORB-SLAM: Tracking and mapping recognizable features. In Workshop on Multi View Geometry in Robotics (MVIGRO)”—RSS 2014, 2014), the more advanced solutions typically rely on substantial computational resources and specialised sensor devices (such as LAser Detection And Ranging—LADAR—sensors, structured light sensors, or time-of-flight depth cameras) which make them difficult to translate to embedded computing devices that tend to control real-world commercial robotic devices such as, for example, relatively low-cost domestic floor cleaning robots.

Therefore, there is a desire for a dense, real-time mapping solution which can be implemented on a low-cost robotic device.

### SUMMARY

According to a first aspect of the present invention, there is provided an apparatus for mapping an observed 3D space. The apparatus comprises a mapping engine configured to generate a surface model for the space, a depth data interface to obtain a measured depth map for the space, a pose data interface to obtain a pose corresponding to the measured depth map, and a differentiable renderer. The differentiable renderer renders a predicted depth map as a function of the surface model and the pose from the pose data interface, and calculates partial derivatives of predicted depth values with respect to the geometry of the surface model. The mapping engine is further configured to evaluate a cost function comprising at least an error between the predicted depth map and the measured depth map, reduce the cost function using the partial derivatives from the differentiable renderer, and update the surface model using geometric parameters for the reduced cost function. Preferably, the differentiable renderer and the mapping engine are further configured to repeat their respective steps, iteratively, re-rendering the predicted depth map using the updated surface model, reducing the cost function, and updating the surface model. Preferably still, the surface model is updated until the depth map optimization (from the cost function minimization) converges.

In certain examples, the surface model comprises a fixed topology triangular mesh. In further examples, the surface model comprises a set of height values in relation to a reference plane within the space.

In some cases, the mapping engine is further configured to apply a threshold limit to the height values to calculate navigable space with respect to the reference plane.

In one variation, the mapping engine implements a generative model, which provides a depth map of the space as a sampled variable given at least the surface model and the pose as parameters.

In a further variation, the mapping engine is configured to linearize an error based on a difference between a measured depth map value and a corresponding rendered depth map value following the iterative minimization of the cost function, and use the said linearized error terms in at least one subsequent update of the surface model. The linearized error terms represent a measure of uncertainty in the estimated surface model. The linearized error terms enable the use of a recursive formulation that allows information from at least one, and typically a plurality, of past measurements to be used as prior probability values. These prior probability values may be jointly minimized with the residual errors calculated in the at least one subsequent update.

In a further example, there is also provided a robotic device incorporating the apparatus described above, and further comprising at least one image capture device to record a plurality of frames comprising one or more of depth data and image data. The robotic device also comprises a depth map processor to determine a depth map from the sequence of frames, and a pose processor to determine a pose of the at least one image capture device from the sequence of frames. The depth data interface of the apparatus is communicatively coupled to the depth map processor of the robotic device, and the pose data interface of the apparatus is communicatively coupled to the pose processor of the robotic device. One or more movement actuators are arranged to move the robotic device within the space, and a controller is arranged to control the one or more movement actuators, and is configured to access the surface model generated by the mapping engine to navigate the robotic device within the space.

In one example, the robotic device comprises a vacuuming system, and in a further example, the controller is arranged to selectively control the vacuuming system in accordance with the surface model generated by the mapping engine.

In some cases the image capture device is a monocular camera.

In a second embodiment of the invention, there is provided a method of generating a model of a 3D space. The method comprises obtaining a measured depth map for the space, obtaining a pose corresponding to the measured depth map, obtaining an initial surface model for the space, rendering a predicted depth map based upon the initial surface model and the obtained pose, obtaining, from the rendering of the predicted depth map, partial derivatives of the depth values with respect to geometric parameters of the surface model, reducing, using the partial derivatives, a cost function comprising at least an error between the predicted depth map and the measured depth map, and updating the initial surface model based on values for the geometric parameters from the cost function. Preferably, the method may be repeated, iteratively, each time rendering an updated predicted depth map based upon the previously updated surface model and the obtained pose, obtaining updated partial derivatives of the depth values with respect to geometric parameters of the previously updated surface model; optimizing the updated rendered depth map by minimizing, using the updated partial derivatives, a cost function comprising at least an error between the updated rendered depth map and the measured depth map, and updating the previous surface model based on values for the geometric parameters from the latest depth map following optimization. The method may be repeated until the optimization converges to a predetermined threshold.

Preferably, the method also comprises obtaining an observed color map for the space, obtaining an initial appearance model for the space, rendering a predicted color map based upon the initial appearance model, the initial surface model and the obtained pose, and obtaining, from the rendering of the predicted color map, partial derivatives of the color values with respect to parameters of the appearance model. The rendered color map is iteratively optimized by minimizing, using the partial derivatives, a cost function comprising an error between the predicted color map and the measured color map, and updating the initial appearance model based on values for the parameters of the appearance model from the color map following iterative optimization.

In some examples, the surface model comprises a fixed topology triangular mesh and the geometric parameters comprise at least a height above a reference plane within the space, and each triangle within the triangular mesh comprises three associated height estimates.

In other cases, the cost function comprises a polynomial function applied to each triangle within the triangular mesh.

In one variation, the predicted depth map comprises an inverse depth map, and for a given pixel of the predicted depth map, a partial derivative for an inverse depth value associated with the given pixel with respect to geometric parameters of the surface model comprises a set of partial derivatives of the inverse depth value with respect to respective heights of vertices of a triangle within the triangular mesh, said triangle being one that intersects a ray passing through the given pixel.

In other variations, the cost function comprises a function of linearized error terms, said error terms resulting from at least one previous comparison of the rendered depth map and the measured depth map, said error terms being linearized from said partial derivatives. In this manner error information from a given comparison, as represented within the partial derivatives, may be used in subsequent comparisons. For example, a set of linearized error terms representing a plurality of past comparisons may be jointly reduced with a set of non-linear error terms representing a current comparison.

In one example, the surface model is updated by reducing the cost function using a gradient-descent method.

In other examples, the method also comprises determining a set of height values from the surface model for the space, and determining an activity program for a robotic device according to the set of height values.

In a third embodiment of the invention, there is provided a non-transitory computer-readable storage medium comprising computer-executable instructions which, when executed by a processor, cause a computing device to obtain an observed depth map for a 3D space, obtain a pose corresponding to the observed depth map, obtain a surface model comprising a mesh of triangular elements, each triangular element having height values associated with vertices of the element, the height values representing a height above a reference plane, render a model depth map based upon the surface model and the obtained pose, including computing partial derivatives of rendered depth values with respect to height values of the surface model, compare the model depth map to the observed depth map, including determining an error between the model depth map and the observed depth map, and determine an update to the surface model based on the error and the computed partial derivatives.

In one example, the computer-executable instructions cause the computing device to, responsive to the update being determined, fuse nonlinear error terms associated with the update into a cost function associated with each triangular element. Preferably, the computer-executable instructions cause the computing device to iteratively optimize the predicted depth map by re-rendering an updated model depth map based upon an updated surface model, until the optimization converges to a predetermined threshold.

### BRIEF DESCRIPTION OF THE DRAWINGS

Further features and advantages of the invention will become apparent from the following description of preferred embodiments of the invention, given by way of example only, which is made with reference to the accompanying drawings, wherein:

FIG. 1 is a graphical representation of a generated height map according to an example;

FIG. 2 is a flow-chart of a method of mapping a 3D space according to an example;

FIG. 3 is a schematic diagram of an apparatus for mapping an observed 3D space according to an example;

FIG. 4 is a schematic block diagram of a robotic device according to an example;

FIG. 5 is a flow chart of a method of mapping a 3D space according to an example;

FIGS. 6A and 6B are schematic diagrams of example robotic devices;

FIGS. 7A and 7B, respectively, are pictorial examples of a 3D space and a corresponding free-space map;

FIG. 8 is a schematic block diagram of a non-transitory computer readable medium according to an example;

FIGS. 9A and 9B, respectively, are schematic diagrams of example generative image formation and rendering processes; and

FIG. 10 is an example of ray-triangle intersection.

### DETAILED DESCRIPTION OF CERTAIN INVENTIVE EMBODIMENTS

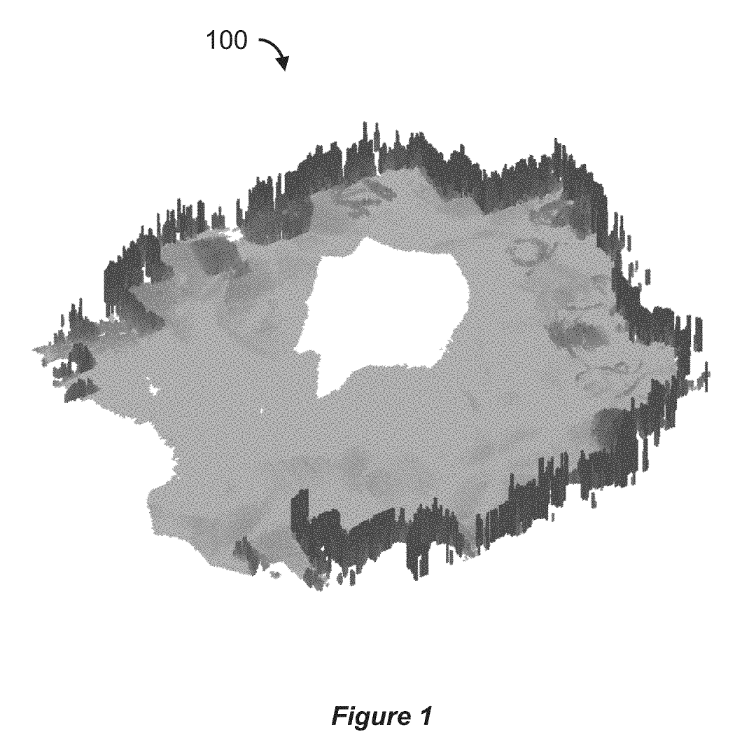

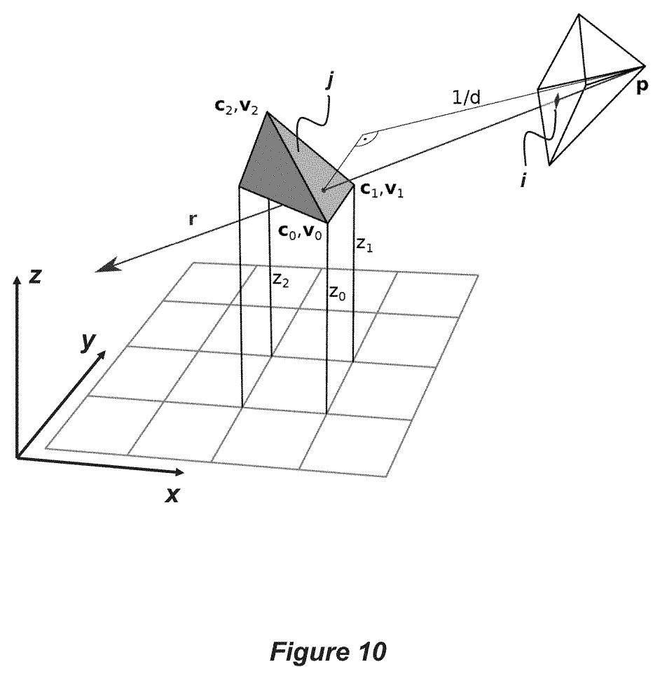

Certain examples described herein relate to apparatus and techniques suitable for mapping a 3D space. FIG. 1 is an example visualisation of a reconstructed height map 100 generated by an example apparatus and method. In a preferred example of the invention, the resultant surface model is modelled as a fixed-topology triangular mesh, which is defined as a height map 100 above a regular two-dimensional (2D) square grid. Each triangular surface element of the mesh is defined by three associated vertices above a reference plane (see also FIG. 10). By forming the surface model as a triangular mesh, data and computational effort can be reduced since adjacent triangular surface elements in the triangular mesh of the surface model share at least two vertices with each other. In more advanced embodiments, the height map may also comprise color information to incorporate image data (not just geometric data) of the 3D space.

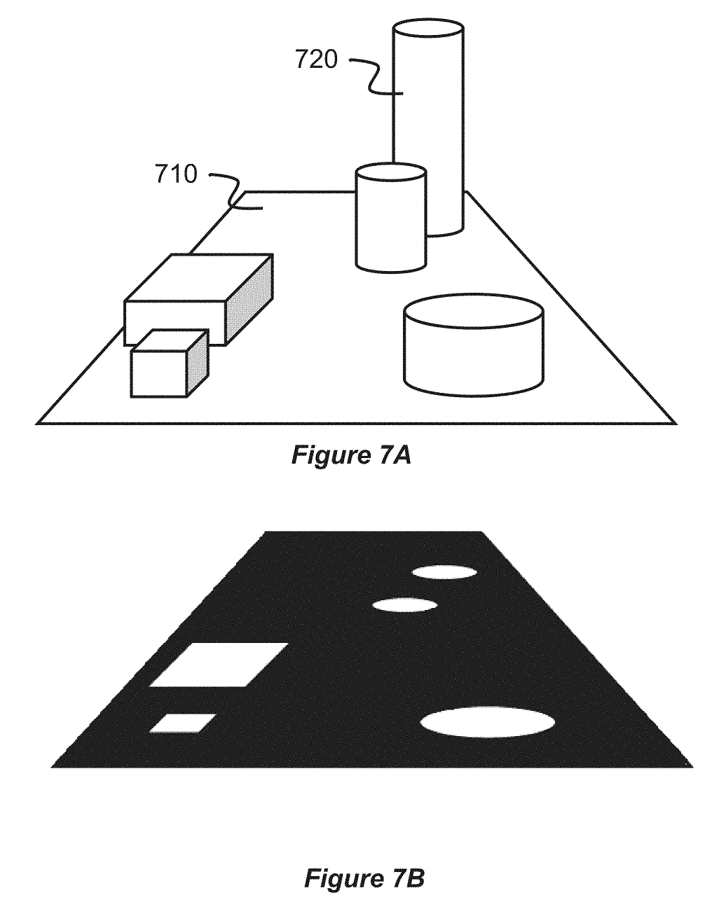

In some examples, the observed depth map data may be used to render (predict) a height map 100 in real-time. The reconstructed height map 100 may be processed to generate a free-space map (see also FIGS. 7A and 7B) to determine portions of the 3D space which are navigable by a robotic device.

### Mapping Method Overview

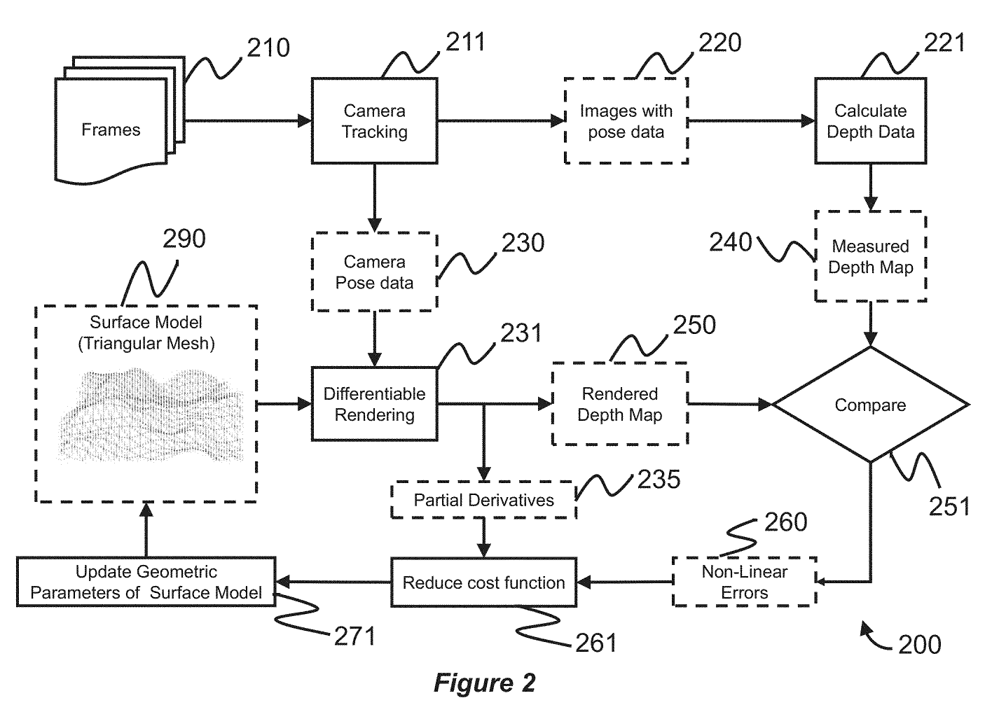

In one example, and with regard to FIG. 2, there is described a robust real-time method 200 of dense reconstruction of high quality height maps, and corresponding surface model 290, as a product of both measured depth map data 240 and camera pose data 230 calculated from frames 210 captured by at least one image capture device, such as a monocular video input, moving through a 3D space. The captured frames 210 are used to estimate, recursively, a surface model 290 and a trajectory of the camera. Motion and pose (i.e. that relating to the location and orientation of the image capture device) data of the camera may be calculated using known camera tracking methods (block 211), such as those based on planar dense visual odometry disclosed by J. Zienkiewicz, R. Lukierski, and A. J. Davison in “Dense, autocalibrating visual odometry from a downward-looking camera” In Proceedings of the British Machine Vision Conference (BMVC), 2013.

For each new captured frame 210, and provided with initial surface model data 290 of a 3D space and camera pose data 230 from the image capture device, a predicted depth map 250 (and optionally a color map if initial color data is provided) is rendered for the observed 3D space using differentiable rendering (block 231). The resultant rendered depth map 250 is compared (block 251) to a measured depth map 240. The measured depth map 240 has been previously calculated (at block 221), for example by using a plane sweep algorithm, for each image frame 210 with corresponding pose data 220 captured by the image capture device. A nonlinear error 260 between the two depth maps (rendered 250 versus measured 240) is calculated. This nonlinear error value 260 is reduced (block 261) using the partial derivative gradient values 235, calculated as part of the differentiable rendering process (block 231), in order to optimize the rendered depth map, and optionally the color map. In a preferred example each cell on the surface map 290 is updated (block 271) according to the optimized depth map.

The optimization of the depth map (blocks 231, 251, 261) for a given frame 210, and subsequent update to the surface model (block 271) is repeated, iteratively, until the optimization “converges”. The convergence of the optimization may, for example, be when the difference between the rendered depth map 250 and the measured depth map 240 falls below a pre-determined threshold value. The updated surface model 290 is used in conjunction with the original pose date 230 for the captured frame 210 to render an updated predicted depth map 250 (and optionally an updated color map if initial color data is provided) using differentiable rendering (block 231). The resultant updated rendered depth map 250 is compared (block 251) to the original measured depth map 240, and the nonlinear error 260 between the two is used in conjunction with the partial derivative gradient values 235 derived from the rendering process (block 231) to reduce the cost function (block 261). This process is repeated until the optimization converges, for example, when the cost function, or error value between the rendered 250 and measured 240 depth maps fall beneath a predetermined threshold. Once the optimization has converged, the resultant depth map may be “fused” into the surface model ready for the next frame 210 to be calculated, in a recursive manner utilizing the latest update to the surface model 290.

The above-described camera tracking (210, 211, 220, 221, 230, 240) and mapping stages (231, 235, 250, 251, 260, 261, 271, 290) may be treated separately to simplify the method. In a first step, only the camera tracking and pose is estimated (block 211), and is subsequently treated as a fixed quantity for the duration of the rendering (block 231) and iterative optimization calculations (231, 235, 250, 251, 260, 261, 271, 290) for the current frame.

The presently disclosed method may be treated as a recursive, nonlinear optimization problem. Once the rendered depth map for a given frame 210 has been optimized (by iteratively minimizing the error value/reducing the cost function—block 261), and the surface model updated (block 271), the method is repeated (recursively) for each subsequent frame 210 captured by the image capture device (in this example a monocular video device) as it moves through a 3D space. Thus, as each new frame arrives, the measured depth data 240 is compared (block 251) with a generative differentiable rendering 250 of the latest surface model depth data estimate, and appropriate Bayesian updates are made to the rendered depth map.

Nonlinear residual values are formulated as the difference between the measured (inverse) depths in the current frame, and the predicted (inverse) depths generated by the rendered depth map. It may be more efficient to utilize the inverse depth values (i.e. 1/actual-depth) in calculations since the estimated distance values for far away objects may be effectively infinite, causing problems in the difference/error calculations. By utilizing inverse depth maps, these large/infinite depth values are instead reduced towards zero.

In order to obtain a recursive formulation and maintain all past measurements, the error terms are linearized and kept as “priors” that are jointly minimized with the residual values (the difference between the observed value and the estimated values) for the current frame.

Using the example efficient differentiable rendering approach enables rigorous incremental probabilistic fusion of standard, locally-estimated depth (and color) into an immediately-usable dense model. Therefore, using only a single forward-looking camera to provide detailed maps suitable for precise autonomous navigation, the present apparatus and method may be employed for free-space and obstacle mapping by low-cost robots.

### Mapping Apparatus Overview

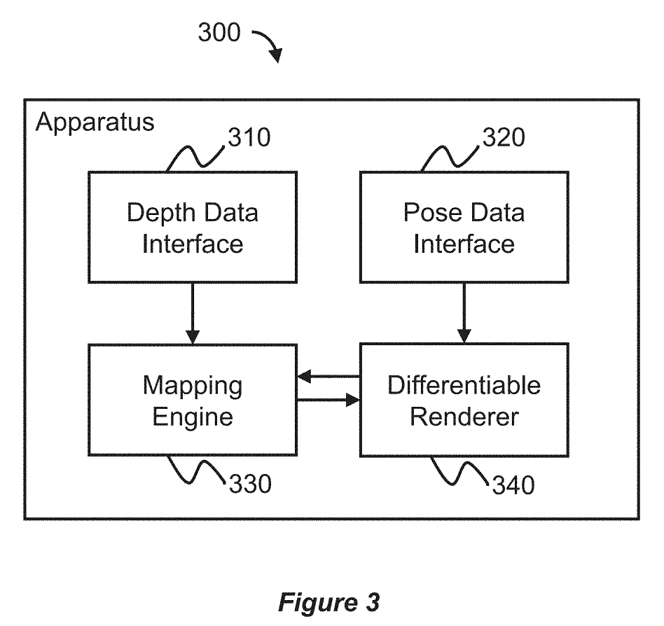

FIG. 3 shows an apparatus 300 according to the present example. The apparatus is configured to render real-time surface models of a 3D space from depth map data and camera pose data retrieved from at least one image capture device, such as a camera. The apparatus 300 comprises a depth data interface 310 to retrieve depth map data and a pose data interface 320 to retrieve pose data (relating to the location and orientation of the image capture device). The apparatus further comprises a mapping engine 330 and a differentiable renderer 340. The depth data interface 310 is coupled with, and delivers depth map data to, the mapping engine 330. The pose data interface 320 is coupled with, and delivers pose data to, the differentiable renderer 340. The mapping engine 330 and differentiable renderer 340 are communicatively coupled to each other.

Incorporation of the Apparatus and Method into a Robotic Device

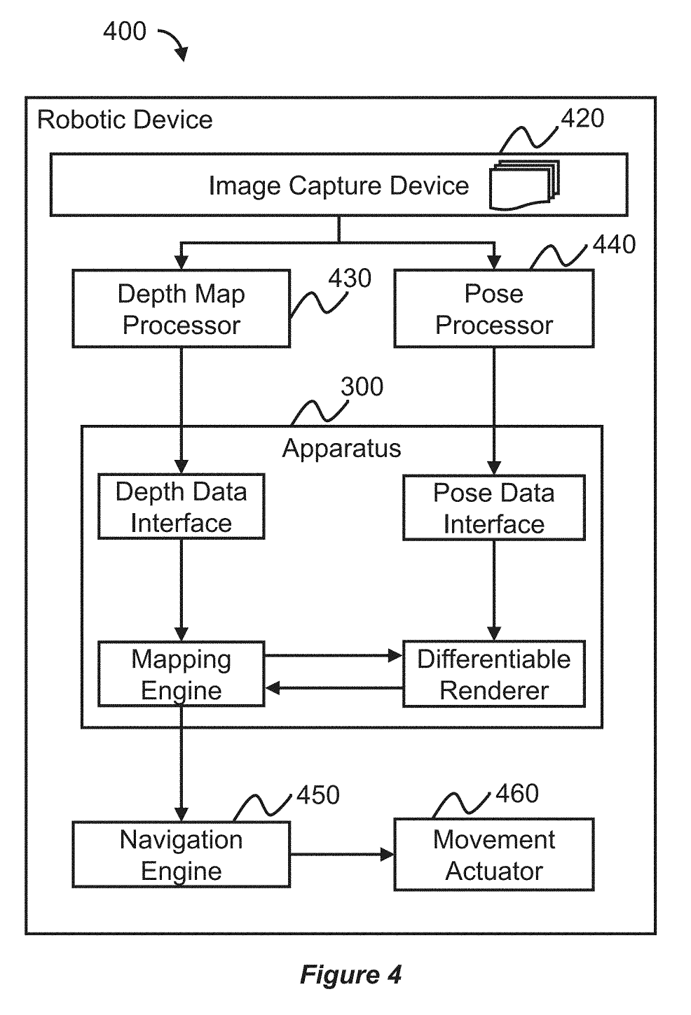

In some examples, the apparatus and method described above may be implemented within a robotic device 400, as shown in FIG. 4. The robotic device 400 incorporates the apparatus 300 of FIG. 3, and further comprises an image capture device 420, which in one example is a camera, which captures image data of a 3D space. In a further example, the camera is a monocular video camera. The image capture device 420 is coupled to a depth map processor 430 and a pose processor 440. The depth map processor 430 calculates depth data from the captured image data, and the pose processor 440 calculates the corresponding camera pose data (i.e. the location and orientation of the image capture device 420). The depth map processor 430 is coupled to the depth data interface 310 of the mapping apparatus 300 (see also FIG. 3). The pose processor 440 is coupled to the pose data 320 interface of the mapping apparatus 300.

The robotic device 400 may also comprise a movement controller, such as a navigation engine 450 and a movement actuator 460. The movement actuator 460 may comprise at least one electric motor coupled, for example, to one or more wheels, tracks and/or rollers, and is arranged to move the robotic device 400 within a 3D space.

Furthermore, the navigation engine 450 of the robotic device 400 may also be coupled to both the mapping engine 330 of the mapping apparatus 300, and the movement actuator 460 of the robotic device 400. The navigation engine 450 controls movement of the robotic device 450 within a 3D space. In operation, the navigation engine 450 uses a “free-space map” (as will be described later on with reference to FIGS. 7A and 7B) to determine navigable portions of the 3D space and instruct the movement actuator 460 so as to avoid any obstacles. For example, the navigation engine 450 may comprise a memory or other machine-readable medium where data implementing the free-space map is stored.

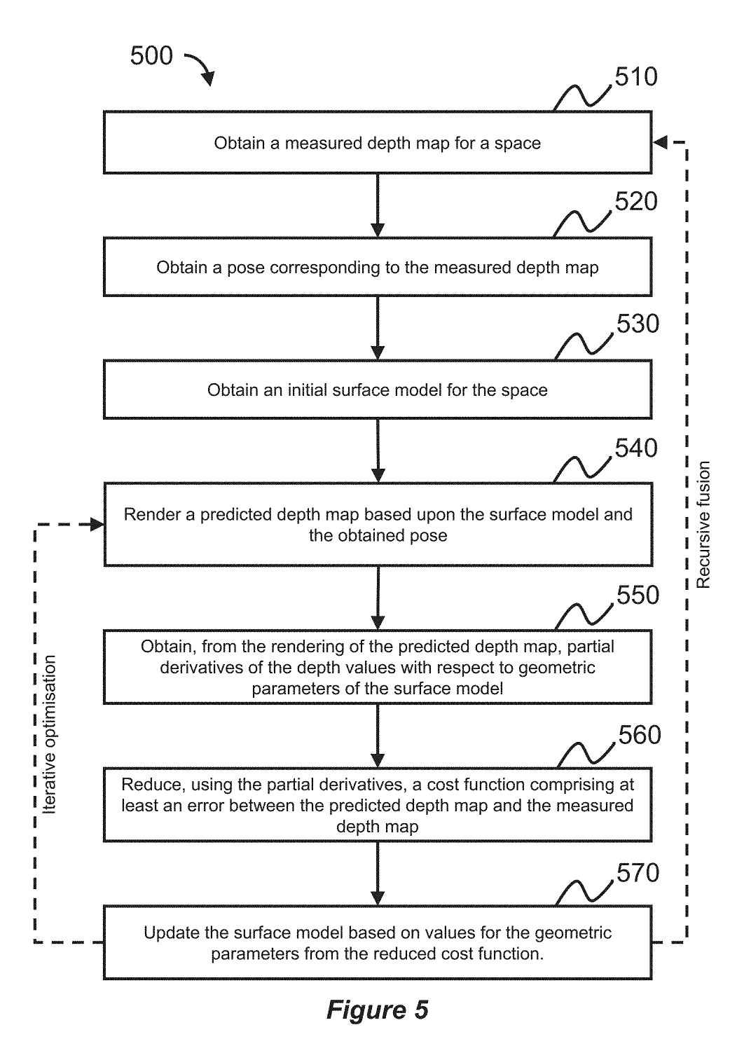

FIG. 5 is a flow chart of a method 500 of mapping a 3D space according to an example. In this example, the image capture device is a monocular camera, moving through a 3D space, capturing multiple images which are used to recursively estimate a surface model, and a trajectory of the camera within the 3D space containing 3D objects located upon a 2D reference plane. This information may be used as an initial state/condition of the surface model.

Depth maps are measured and calculated by the depth map processor 430 from the retrieved image frames 210 of the 3D space, for example using a plane sweep algorithm, and communicated to the depth data interface 310 of the apparatus (block 510).

Frame-to-frame motion and pose data of the camera is calculated by a pose processor 440 (using techniques as discussed above). The camera pose data is retrieved by the pose data interface 320 of the mapping apparatus 300 and forwarded to the differentiable renderer 340 (block 520).

As outlined previously with reference to FIG. 2, the mapping engine 330 of the apparatus 300 uses preliminary estimates of the conditions of the 3D space (in the form of initial geometry, appearance and camera pose values—such as there being a predominant reference plane, or the height of the camera above the reference plane) to generate an initial surface model of the 3D space (block 530). This initial surface model, along with the camera pose data retrieved by the pose data interface 320, is used by the differentiable renderer 340 to render a predicted depth map of the observed scene (block 540). An important element of the method is that, given the initial surface model and camera pose data, the differentiable renderer 340 can calculate the (partial) derivatives of the depth values with respect to the model parameters (block 550), as well as render a predicted image and depth for every pixel, at almost no extra computational cost. This allows the apparatus to perform gradient-based minimization in real-time by exploiting parallelisation. The rendered depth map of the frame is compared directly to the measured depth map retrieved from the depth map processor 430 by the depth data interface 310, and a cost function of the error between the two maps is calculated. The partial derivative values calculated by the differentiable rendering process (block 550) are subsequently used to reduce the cost function of the difference/error between the predicted 250 and the measured 240 depth maps (block 560), and therefore optimize the depth map. The initial surface model is updated with the values for the geometric parameters derived from the reduced cost function (block 570) and optimized depth map.

The updated surface model along with the initial camera pose data (from block 520) is subsequently used by the differentiable renderer 340 to render an updated predicted depth map of the observed scene (block 540). The updated rendered depth map of the frame is compared directly to the original measured depth map for the frame (from block 510), and a cost function (including the error between the two maps) is reduced using the partial derivative values calculated by the differentiable rendering process (block 550). The surface model is updated, again, following optimization and the process (blocks 540, 550, 560, 570) is repeated, iteratively, until the optimization of the rendered depth map converges. The optimization may, for example, continue until the error term between the rendered and measured depth maps falls below a pre-determined threshold value.

After the iterative optimization process, the linearized error terms may also be updated. The linearized error terms represent an uncertainty of previously calculated values, and are used to create polynomial (in this example, quadratic) constraints on how the vertices of each triangular surface element of the surface model (in this example a triangular mesh) can be further modified/displaced in future recursions (e.g. at each frame) after the iterative optimization of the current (frame) depth map has been completed, and “fused” (i.e. included) into the latest surface model. The constraints are built from the residual errors between the rendered 250 and measured (“observed”) 240 depth maps.

The present example method combines a generative model approach and differentiable rendering process to maximise a likelihood function for each observed frame/scene 210, by which the method actively attempts to configure the rendered surface model to best represent the observed 3D space.

Furthermore, the linearized error terms allow a full posterior distribution to be stored and updated. The per-triangle nature of the information filters, rather than per-vertex, takes into account the connections between individual cells (vertices) on the map and discards no information while keeping computational complexity bounded.

The whole process is repeated for each frame captured, with each updated surface model replacing the previous model.

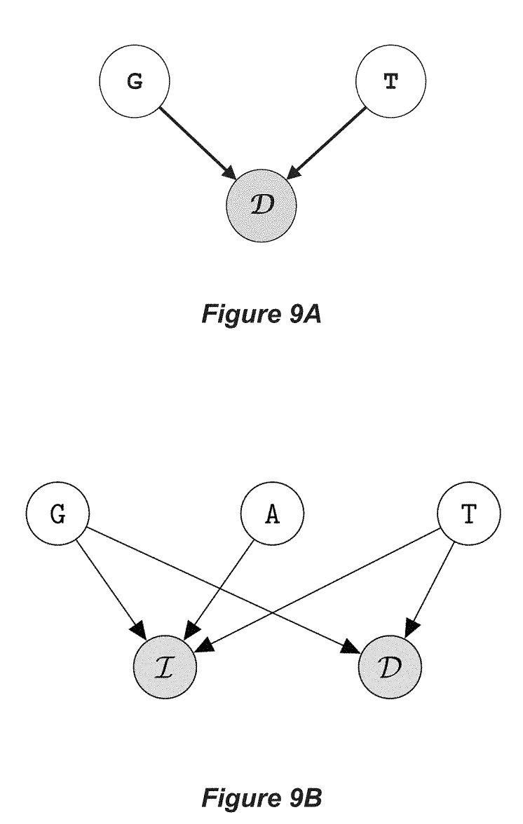

Whilst the apparatus and method described are primarily directed towards resolving a depth map, additional color data may be incorporated into the resultant height map/surface model and optimized during the process as well. In this case, the method is similar to that above, but includes some additional steps. Firstly, an observed color map for the 3D space is obtained, alongside an initial “appearance model” for the 3D space (using initial appearance parameters). A predicted color map is rendered based upon the initial appearance model, the initial surface model and the obtained camera pose data (see also FIG. 9B). From the rendering of the predicted color map, partial derivatives of the color values with respect to parameters of the appearance model are calculated. A cost function is derived which comprises the error between the predicted depth map and the measured depth map, and an error between the predicted color map and the measured color map. Following reduction of the cost function (using the partial derivatives generated during the rendering process), the initial appearance model is then updated based upon the appearance parameter values. The process may be repeated, iteratively, until the color map optimization converges.

### Example Robotic Devices

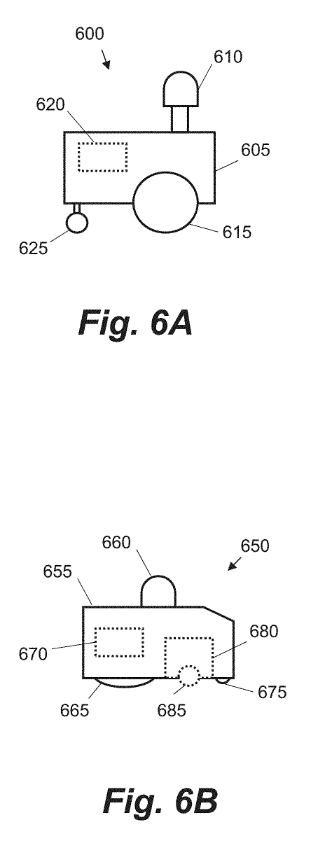

FIG. 6A shows a first example 600 of a robotic device 605 that may be equipped with the mapping apparatus 300. This robotic device is provided for ease of understanding of the following examples and should not be seen as limiting; other robotic devices having different configurations may equally apply the operations described in the following passages. The robotic device 605 of FIG. 6A comprises a monocular camera device 610 to capture image data. In use, multiple images may be captured, one after each other. In the example of FIG. 6A, the camera device 610 is mounted on an adjustable arm above the robotic device; wherein the elevation and/or orientation of the arm and/or camera may be adjusted as desired. In other cases, the camera device 610 may be statically-mounted within a body portion of the robotic device 605. In one case, the monocular camera device may comprise a still image device configured to capture a sequence of images; in another case, the monocular camera device 610 may comprise a video device to capture video data comprising a sequence of images in the form of video frames. It certain cases, the video device may be configured to capture video data at a frame rate of around, or greater than, 25 or 30 frames per second. The robotic device may comprise a navigation engine 620, and in the present example, the robotic device is equipped with a set of driven wheels 615 arranged in relation to the body portion of the robotic device 605, and a rotatable free-wheel 625.

FIG. 6B shows another example 650 of a robotic device 655. The robotic device 655 of FIG. 6B comprises a domestic cleaning robot. Like the robotic device 605 in FIG. 6A, the domestic cleaning robotic device 655 comprises a monocular camera device 660. In the example of FIG. 6B, the monocular camera device 660 is mounted on the top of the cleaning robotic device 655. In one implementation, the cleaning robotic device 655 may have a height of around 10 to 15 cm; however, other sizes are possible. The cleaning robotic device 655 also comprises at least one movement actuator 665. In the present case the movement actuator 665 comprises at least one electric motor arranged to drive two sets of tracks, which are mounted on either side of the robotic device 655, to propel the robotic device forwards and backwards. The tracks may further be differentially driven to steer the domestic cleaning robotic device 655. In other examples, different drive and/or steering components and technologies may be provided. As in FIG. 6A, the cleaning robotic device 655 comprises a navigation engine 670 and a rotatable free-wheel 675.

In addition to the components of the robotic device 605 shown in FIG. 6A, the cleaning robotic device 655 comprises a cleaning element 680. This cleaning element 680 may comprise an element to clean a floor of a room. It may comprise rollers or brushes 685 and/or wet or dry elements. In one case, the cleaning element 680 may comprise a vacuum device arranged to capture dirt and dust particles. The navigation engine may be configured to use a free-space map (as described below with reference to FIGS. 7A and 7B), generated by the apparatus and method described above, to determine a cleaning pattern for unoccupied areas of the 3D space, and instruct activation of the cleaning element 680 according to the cleaning pattern. For example, a vacuum device may be activated to clean an area of free-space within a room, as indicated by the generated free-space map, wherein the cleaning robotic device navigates obstacles within the room using the free-space map. Furthermore, the navigation engine 670 of the robotic device 655 may use the generated height map to control vacuum device activity, for example to identify specific areas within a 3D space for cleaning. For example, the navigation engine of the robotic device may: activate the vacuum device as the robotic device 655 is steered along a crevice in a floor surface; increase the suction power of the vacuum device when the robotic device 655 encounters a crevice; or stop the cleaning element 680 as the robotic device 655 encounters a loose cable, to avoid becoming entangled.

### Free-Space Mapping

A desirable property of the generated surface model is that it can be directly used for robot navigation and obstacle avoidance in a 3D space. In a preferred example, the reconstruction is based upon a triangular mesh atop a height map representation, and therefore a threshold may be applied to the calculated height values to generate usable quantities such as the drivable free-space area or a classification of walls, furniture and small obstacles based on their height.

FIGS. 7A and 7B illustrate the results of applying this approach to a 3D space with multiple obstacles 720 located on a reference plane 710 (see FIG. 7A). For each pixel in an image, the height of associated grid cell (on the reference plane 710) is checked and labelled as a free-space based on a fixed threshold, for example lcm above the reference plane 710, that a robotic device would be able to safely traverse. A free-space map (FIG. 7B) is subsequently overlaid onto the observed image, highlighting the navigable area (shown as shaded in FIG. 7B) within a 3D space. Despite the fact that a height map cannot correctly model overhangs, the method may exhibit correct behaviour even in these scenarios and prevent the robot from running into low-hanging obstacles, even though the area immediately above ground is clear. The method in its current implementation is surprisingly robust, especially for the task of free-space detection. Further exemplary approaches could evaluate the gradient of the height map to determine roughness of the terrain and whether or not the 3D space was traversable.

Any one of the mapping apparatus 300 and navigation engine 450 above may be implemented upon a computing device embedded within a robotic device (as indicated by the dashed lines 620, 670 in FIGS. 6A and 6B). The mapping apparatus 300 or navigation engine 450 may be implemented using at least one processor and memory and/or one or more system-on-chip controllers. In certain cases, the navigation engine 450 or mapping apparatus 300 may be implemented by way of machine-readable instructions, for example firmware as retrieved from a read-only or programmable memory such as an erasable programmable read-only memory (EPROM).

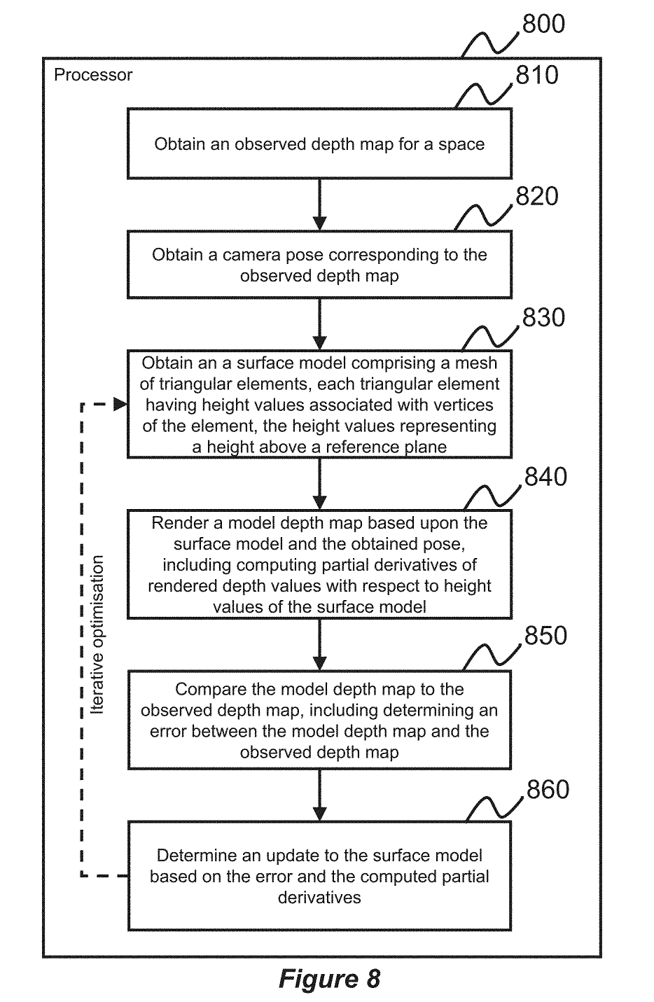

FIG. 8 shows a processor 800 equipped to execute instructions stored on a non-transitory computer-readable storage medium. When executed by the processor, the instructions cause a computing device to obtain an observed depth map for a space (block 810); obtain a camera pose corresponding to the observed depth map (block 820); obtain a surface model (in this example comprising a mesh of triangular elements, each triangular element having height values associated with vertices of the element, the height values representing a height above a reference plane) (block 830); render a model depth map based upon the surface model and the obtained pose, the rendering including computing partial derivatives of rendered depth values with respect to height values of the surface model (block 840); compare the model depth map to the observed depth map, including determining an error between the model depth map and the observed depth map (block 850); and determine an update to the surface model based on the error and the computed partial derivatives (block 860). For each observed depth map (i.e. captured image/frame), the final four steps may be repeated, iteratively, until the rendered depth map optimization (i.e. through minimization of the error between the rendered and the observed depth maps) converges. The convergence of the optimization process may involve the error value between the rendered and the measured depth maps falling below a predetermined threshold.

In a further example, once the surface model update is determined, the computer-executable instructions cause the computing device to fuse nonlinear error terms associated with the update into a cost function associated with each triangular element.

### The Generative Model

The present approach is based on a probabilistic generative model, and FIG. 9A and FIG. 9B are schematic diagrams outlining the relationship between the geometry G, camera pose T and appearance A parameters of a 3D space, to the image I and depth data D in a generative model. The geometry G of the 3D space is related to the shape and form of the 3D space, whilst the appearance A is related to the colors/aesthetics. Whilst the present approach is primarily directed towards modelling the depth of a 3D space, thus requiring input from the geometry and pose only (shown in FIG. 9A), it would be easily understood by any person skilled in the art that the described apparatus and methods could be easily expanded to model the image data I as well by including appearance data (shown in FIG. 9B). The following detailed description deals with both the image I and depth data D representations.

Within a 3D space to be mapped, any given surface is parametrised by its geometry G and its appearance A. The “pose” of an image capture device such as a camera, and therefore any image taken with it, is the location and orientation of the camera within a given 3D space. A camera with an associated pose T in the 3D space samples the current frame, and an image I and an inverse depth (i.e. 1/actual-depth) map D are rendered.

Employing Bayesian probability techniques, the joint distribution that models the image formation process is:

P(I, D, G, A, T)=P(I|G, A, T)P(D|G, T)P(G)P(A)P(T)

The relationship between image observations and surface estimation can be also expressed using Bayes rule:

P(G, A, T|I, D)∝P(I, D|G, A, T)P(G)P(A)P(T)

This allows the derivation of a maximum a-posteriori (MAP) estimate of the camera pose and surface:

argmax_{G,A,T}P(I, D|G, A, T)P(G)P(A)P(T)

The term P(I, D|G, A, T) is a likelihood function which can be evaluated and differentiated using the differentiable renderer. No assumptions are made regarding the geometry and/or colors of the frame, and the problem is treated as one of maximum likelihood. The camera pose is treated as given by a dense tracking module. With these simplifications and taking the negative logarithm of the equation above, the following minimization problem is obtained:

argmin_{G,A}F(G, A, T)

with:

F(G, A, T)=∥\tilde{D}−D(G, T)∥_{ΣD}+∥Ĩ−I((G, A, T)∥_{ΣI}

Here \tilde{D} and Ĩ represent, respectively, the measured (observed) inverse depth map and image with associated measurement uncertainties modelled by (diagonal) covariance matrices Σ_{D} and Σ_{I}, whereas D and I denote the rendered predicted inverse depth map and image using the current estimates of G, A, and a given T. Even though the differentiable rendering process and therefore the function F(G, A, T) is nonlinear, having access to some initial estimates of G₀, A₀, T₀, as well being able to evaluate the cost function F and its derivative with respect the model parameters, allows an estimate of the standard nonlinear least squares to be found in an iterative fashion. In particular the partial derivatives

$$\frac{\partial I}{\partial G} and \frac{\partial I}{\partial A} ,$$

as well

$$\frac{\partial D}{\partial G}$$

are required to De calculated, and are obtained from the differentiable rendering process, for almost no extra computational cost, by the differentiable renderer.

### Differentiable Rendering

The differentiable rendering method is based upon a weighted optimization of the depth map values (and optionally the color map values for the more advanced image modelling) as each new image (frame) is received. While the method utilizes the nonlinear error terms between the rendered and predicted depth (and optionally color) maps of the latest frame captured, all previous such error measurements are kept as “prior” linear error terms to determine the polynomial (in this example, quadratic) constraints on how the vertices of the surface model (in this example, a triangular mesh) can be further modified/displaced after an optimize depth map has been fused into the surface model, as described below. Therefore, as more data is collected, rendered, optimized and fused into the surface model, the more robust the model becomes.

The optimization process requires several iterations, and the number of measurements and the size of the state space are high, though any Jacobian matrixes (a matrix of all first-order partial derivatives of a vector-valued function) linking them are sparse. The present method is highly efficient owing to the differentiable rendering approach, wherein at each iteration of the optimization, the inverse depth (and optionally the color measurement) likelihood function is re-evaluated by rendering the predictions. At the same time, the per-pixel elements of the Jacobian matrixes that will be used for the optimization stage are also calculated. When correctly implemented this can be done at almost no additional computational cost.

With regards to FIG. 10, let r(t) be a ray, parameterised by its starting point p∈R³ and direction vector d∈R³, wherein r(t)=p+td, with t≥0. For each pixel in the image a ray can be calculated using camera intrinsics and the center of the camera frame of reference as the origin. The example surface triangle is parameterised by 3 vertices, v₀, v₁, v₂, where v₀, v₁v₂ represent points in 3D space, e.g. v₁=(x₁,y₁,z₁). The ray/triangle intersection is calculated (for example using the Möller-Trumbore ray-triangle intersection algorithm discussed in the 1997 paper titled “Fast, Minimum Storage Ray/Triangle Intersection” by Tomas Möller and Ben Trumbore) and yields a vector (t,u,v)^{T}, where t is the distance to the plane in which the triangle lies and u, v are the barycentric coordinates of the ray intersection point with respect to the triangle (note: the barycentric coordinate v is different to the 3D vertex coordinates v₀, v₁, v₂).

The t, u, and v are the essential elements required to render a depth (t) and a color (u and v) for a particular pixel. The depth value t is directly related to the depth, whereas the barycentric coordinates (u and v) are used to interpolate the color c based on the RGB color triangle vertices (c₀, c₁, c₂) in the following way:

c=(1−u−v)c₀+uc₁+vc₂.

The rendered inverse depth dⁱ of a pixel i depends only on the geometry of the triangle that a ray is intersecting (and camera pose, that is assumed to be fixed for a given frame). In one example, the surface model is modelled using a height map, wherein each vertex has only one degree of freedom, its height z. Assuming that the ray intersects the triangle j specified by heights z₀, z₁, z₂, at distance 1/dⁱ (where dⁱ is the inverse depth for a pixel i), the derivative can be expressed as follows:

$$\frac{\partial {d}^{i}}{\partial {G}^{j}} = [ \frac{\partial {d}^{i}}{\partial {z}_{0}} \frac{\partial {d}^{i}}{\partial {z}_{1}} \frac{\partial {d}^{i}}{\partial {z}_{2}} ]$$

If the more advanced step of differentiating color/appearance is employed, the rendered color cⁱ of pixel i depends both on the triangle (j) geometry as well as the per vertex color. The derivative of the rendered color with respect to vertex colors is simply the barycentric coordinates:

$$\frac{\partial {c}^{i}}{\partial {A}^{j}} = [ \frac{\partial {c}^{i}}{\partial {c}_{0}} \frac{\partial {c}^{i}}{\partial {c}_{1}} \frac{\partial {c}^{i}}{\partial {c}_{2}} ] = [ ( 1 - u - v ) IuIvI ]$$

In this example, I denotes the identity matrix (3×3 in this case). Since in this loosely-coupled fusion, the color image has already been used to generate a depth map that determines the height map, the dependency of the color image on the height map is ignored, i.e. the respective derivative are not calculated. This is a conservative assumption in order that the colors and height maps may be treated independently. In essence, the color estimation simply serves to improve the representation of the height map.

Height Map Fusion through Linearization

The inverse depth error term as described above is of the form:

e¹=\tilde{d}ⁱ−dⁱ)z^{j})

Where zⁱ denotes the heights of the triangle j intersected by the ray through pixel i. This is a scalar adaption of the depth component of the minimization problem outlined previously. In this example z^{j}=[z₀, z₁, z₂]^{T}. After the optimization is completed, the error term is approximated linearly around the current estimate z̅^{j} as:

eⁱ∞ēⁱ+Eδz=ēⁱ−Ez̅^{j}+Ez^{j}=:eᵢⁱ

The Jacobian matrix E was computed as part of the gradient descent as:

$$- \frac{\partial {d}^{i}}{\partial {G}^{j}}$$

After a frame has been fused into the surface model, the polynomial (in this example a quadratic) cost is accumulated on a “per-triangle” basis. These linearized error terms create polynomial (in this example, quadratic) constraints on how the vertices of the surface model (in this example, a triangular mesh) can be further modified/displaced after a depth map has been fused into the surface model. The constraints are built from the residual errors between the rendered and observed depth maps. Therefore, for each triangle j, a quadratic cost term is kept of the form:

c=c₀+b^{T}_{z}+z^{T}Az

Wherein the values of c₀, b, and A are initially zero. The gradient of these cost terms can be obtained in a straight-forward manner, and the per-triangle cost update (simply summing) based on the current linearized error term thus consists of the following operation:

$${c}^{+} = c + \frac{{( {e}_{l}^{i} )}^{2}}{{σ}_{d}^{2}}$$

Multiplying this out and rearranging provides the updates to the coefficient of the per-triangle quadratic cost:

$${c}_{0}^{+} = {c}_{0} + \frac{{( {\overline{e}}^{i} - E {\overline{z}}^{j} )}^{2}}{{σ}_{d}^{2}}$$

$${b}^{+} = b + 2 ( {\overline{e}}^{i} - E {\overline{z}}^{j} ) E$$

$${A}^{+} = A + {E}^{T} E \frac{1}{{σ}_{d}^{2}}$$

The overall cost concerning the height map, F_{z}, thus amounts to:

$${F}_{z} = {\sum }_{j} {c}^{j} + {\sum }_{i} {( {e}^{i} )}^{2} \frac{1}{{σ}_{d}^{2}}$$

Wherein eⁱ is the pixel difference between the measured and the rendered depth as described earlier, j is the sum over all triangles, and i is the sum over all pixels. After the optimization terminates (converges), the fusion of the current nonlinear depth error terms is performed into all the quadratic per-triangle cost terms. Note that, consequently, the number of linear cost terms is bounded by the number of triangles in the height map, whereas the number of nonlinear (inverse) depth error terms is bounded by the number of pixels in the image capture device. This is an important property for real-time operation.

As an example, the per-triangle error terms are initially set to zero, and the first depth map is fused into the surface model. After the first depth map has been fused into the surface model, the per-triangle quadratic constraints are updated, and they are used as the priors (“spring” constraints) for the fusion of the next depth map. This process is then repeated.

Note furthermore that color fusion is not at addressed here, but the skilled person could extend the above formulation in a straight-forward manner. Since the color information is only used in this example for improved display of the height map, the preferred method abandons fusing the color and only uses the current frame nonlinear color error terms in the overall cost function.

### Optimization

The height map fusion is formulated as an optimization problem. Furthermore, by means of differentiable rendering, the gradient of the associated cost function may be accessed without any considerable increase in computational demand When optimizing the depth map (and optionally the color map) for each new frame 210, the apparatus and method iteratively solves a nonlinear “least squares” problem. A standard procedure, at each iteration, would require forming a normal equation and solving, it for example by means of Cholesky factorization. However, due to the size of the problem to be solved, using direct methods that form the Hessian explicitly, and rely on matrix factorization, are prohibitively expensive.

Instead, the conjugate gradient descent algorithm is used, which is indirect, matrix-free and can access the Hessian through a dot product. At each iteration of conjugate gradient it is required to perform a line search in order to determine the step size in the descent direction. This requires a re-evaluation of the cost function. When evaluating the cost function with the present method, the gradient may be almost instantaneously accessed, and the optimal step size is not searched for, but instead the method accepts any step size that leads to a decrease in the cost, and in the next iteration the already-available gradient is used. Typically about 10-20 iterations are required until the optimization process converges, which in the current implementation allows the described fusion to run at a rate of about 15-20 fps. Convergence may occur, for example, when the error value between the rendered and the measured depth maps falls below a predetermined threshold value.

### Summary

The disclosed apparatus and method provide a number of benefits over the prior art. Given the probabilistic interpretation and generative model used, Bayesian fusion using a “per triangle” information filter is performed. The approach is optimal up to linearization errors, and discards no information, while the computational complexity is bounded.

The method is highly scalable, both in terms of image resolution and scene representation. Using current GPUs, rendering can be done extremely efficiently, and calculating the partial derivatives comes at almost negligible cost. The disclosed method is both robust and efficient when applied directly to mobile robotics.

The above embodiments are to be understood as illustrative examples of the invention. Further embodiments are envisaged. For example, there exist many different types of camera and image retrieval methods. The depth, image and camera pose and tracking data might each be obtained from separate sources, for example depth data from a dedicated depth camera (such as the Microsoft Kinect™) and image data from a standard RGB camera. Furthermore, the tracking may also be directly integrated into the mapping process. In one example, the five most-recent frames are used to derive the depth maps for a single frame.

It is to be understood that any feature described in relation to any one embodiment may be used alone, or in combination with other features described, and may also be used in combination with one or more features of any other of the embodiments, or any combination of any other of the embodiments. It should be noted that use of method/process diagrams is not intended to imply a fixed order; for example in FIG. 5, block 520 may be performed before block 510. Alternatively, blocks 510 and 520 may be performed simultaneously.

Furthermore, equivalents and modifications not described above may also be employed without departing from the scope of the invention, which is defined in the accompanying claims.

What is claimed is:

1. An apparatus for mapping an observed 3D space, the apparatus comprising:
a mapping engine configured to generate a surface model for the space;
a depth data interface to obtain a measured depth map for the space;
a pose data interface to obtain a pose corresponding to the measured depth map; and
a differentiable renderer configured to:
render a predicted depth map as a function of the surface model and the pose from the pose data interface; and
calculate partial derivatives of predicted depth values with respect to the geometry of the surface model,
wherein the mapping engine is further configured to:
evaluate a cost function between the predicted depth map and the measured depth map;
reduce the cost function using the partial derivatives from the differentiable renderer; and
update the surface model using geometric parameters for the reduced cost function.

2. The apparatus according to claim 1, wherein the differentiable renderer and the mapping engine are further configured to iteratively optimize the surface model by:
re-rendering the predicted depth map using the updated surface model;
reducing the cost function; and
updating the surface model.

3. The apparatus according to claim 2, wherein the differentiable renderer and the mapping engine continue to iteratively optimize the surface model until the optimization of the depth map converges to a predetermined threshold.

4. The apparatus according to claim 1, wherein
the surface model comprises a fixed topology triangular mesh.

5. The apparatus according to claim 1, wherein
the surface model comprises a set of height values in relation to a reference plane within the space.

6. The apparatus according to claim 5, wherein
the mapping engine is further configured to apply a threshold limit to the height values to calculate navigable space within the 3D space with respect to the reference plane.

7. The apparatus according to claim 1, wherein
the mapping engine implements a generative model providing a depth map of the space as a sampled variable given at least the surface model and the pose as parameters.

8. The apparatus according to claim 3, wherein the mapping engine is further configured to:
linearize an error based on the difference between a measured depth map value and a corresponding rendered depth map value following the iterative minimization of the cost function; and
use said linearized error terms in at least one subsequent recursive update of the surface model.

9. A robotic device comprising:
at least one image capture device to record a plurality of frames comprising one or more of depth data and image data;
a depth map processor to determine a depth map from the sequence of frames;
a pose processor to determine a pose of the at least one image capture device from the sequence of frames;
a mapping apparatus for mapping an observed 3D space, the apparatus comprising:
a mapping engine configured to generate a surface model for the space;
a depth data interface to obtain a measured depth map for the space, wherein the depth data interface is communicatively coupled to the depth map processor;
a pose data interface to obtain a pose corresponding to the measured depth map, wherein the pose data interface is communicatively coupled to the pose processor; and
a differentiable renderer configured to:
render a predicted depth map as a function of the surface model and the pose from the pose data interface; and
calculate partial derivatives of predicted depth values with respect to the geometry of the surface model,
wherein the mapping engine is further configured to:
evaluate a cost function between the predicted depth map and the measured depth map;
reduce the cost function using the partial derivatives from the differentiable renderer; and
update the surface model using geometric parameters for the reduced cost function, the robot device further comprising:
one or more movement actuators arranged to move the robotic device within the 3D space; and
a controller arranged to control the one or more movement actuators, wherein the controller is configured to access the surface model generated by the mapping engine to navigate the robotic device within the 3D space.

10. The robotic device according to claim 9, further comprising a vacuuming system.

11. The robotic device according to claim 10, wherein the controller is arranged to selectively control the vacuuming system in accordance with the surface model generated by the mapping engine.

12. The robotic device according to claim 9, wherein the image capture device is a monocular camera.

13. A method of generating a model of a 3D space, the method comprising:
obtaining a measured depth map for the space;
obtaining a pose corresponding to the measured depth map;
obtaining an initial surface model for the space;
rendering a predicted depth map based upon the initial surface model and the obtained pose;
obtaining, from the rendering of the predicted depth map, partial derivatives of the depth values with respect to the geometric parameters of the surface model;
reducing, using the partial derivatives, a cost function comprising at least an error between the rendered depth map and the measured depth map; and
updating the initial surface model based on values of the geometric parameters from the reduced cost function.

14. The method according to claim 13, wherein the method is repeated, iteratively:
optimizing the predicted depth map by re-rendering based upon the updated surface model and the obtained pose;
obtaining updated partial derivatives of the updated depth values with respect to the geometric parameters of the updated surface model;
minimizing, using the updated partial derivatives, a cost function comprising at least an error between the updated rendered depth map and the measured depth map; and
updating the surface model based on the geometric parameters for the minimized cost function.

15. The method according to claim 14, wherein
the method continues iteratively until the optimization of the depth map converges to a predetermined threshold.

16. The method according to claim 13, further comprising:
obtaining an observed color map for the space;
obtaining an initial appearance model for the space;
rendering a predicted color map based upon the initial appearance model, the initial surface model and the obtained pose;
obtaining, from the rendering of the predicted color map, partial derivatives of the color values with respect to parameters of the appearance model; and
iteratively optimizing the rendered color map by:
minimizing, using the partial derivatives, a cost function comprising at least an error between the rendered color map and the measured color map;
and
updating the initial appearance model based on values for the parameters of the appearance model from the minimized cost function.

17. The method according to claim 13, wherein
the surface model comprises a fixed topology triangular mesh and the geometric parameters comprise at least a height above a reference plane within the space, wherein each triangle within the triangular mesh comprises three associated height estimates.

18. The method according to claim 17, wherein
the cost function comprises a polynomial function applied to each triangle within the triangular mesh.

19. The method according to claim 17, wherein
the predicted depth map comprises an inverse depth map, and for a given pixel of the predicted depth map, a partial derivative for an inverse depth value associated with the given pixel with respect to geometric parameters of the surface model comprises a set of partial derivatives of the inverse depth value with respect to respective heights of vertices of a triangle within the triangular mesh, said triangle being one that intersects a ray passing through the given pixel.

20. The method according to claim 14, wherein
the cost function comprises a function of linearized error terms, said error terms resulting from at least one previous comparison of the rendered depth map and the measured depth map, said error terms being linearized from said partial derivatives.

21. The method according to claim 13, wherein
updating a surface model by reducing the cost function comprises using a gradient-descent method.

22. The method according to claim 13, comprising:
determining a set of height values from the surface model for the 3D space; and
determining an activity program for a robotic device according to the set of height values.

23. A non-transitory computer-readable storage medium comprising computer-executable instructions which, when executed by a processor, cause a computing device to:
obtain an observed depth map for a 3D space;
obtain a pose corresponding to the observed depth map;
obtain a surface model comprising a mesh of triangular elements, each triangular element having height values associated with vertices of the element, the height values representing a height above a reference plane;
render a model depth map based upon the surface model and the obtained pose, including computing partial derivatives of rendered depth values with respect to height values of the surface model;
compare the model depth map to the observed depth map, including determining an error between the model depth map and the observed depth map; and
determine an update to the surface model based on the error and the computed partial derivatives.

24. The non-transitory computer-readable storage medium according to claim 23, wherein, responsive to the update being determined, the computer-executable instructions cause the computing device to:
fuse nonlinear error terms associated with the update into a cost function associated with each triangular element.

25. The non-transitory computer-readable storage medium according to claim 23, wherein the computer-executable instructions cause the computing device to iteratively optimize the predicted depth map by rendering an updated model depth map based upon an updated surface model, until the optimization converges to a predetermined threshold.
